(19) United States
(12) Patent Application Publication
(10) Pub. No.: US 2009/0026677 A1
(43) Pub. Date: Jan. 29, 2009

(54) VACUUM TYPE POSITIONING APPARATUS

(75) Inventors: GAO-WEN LIU, Shenzhen (CN); ZHI-QIANG CHEN, Shenzhen (CN); TAO WEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/946,461

(22) Filed: Nov. 28, 2007

(30) Foreign Application Priority Data
Jul. 25, 2007 (CN) 200710075297.8

(51) Int. Cl. B25B 11/00

(52) U.S. Cl. 269/21

(57) ABSTRACT

A vacuum type positioning apparatus (10), used in insert-molding machine for positioning an inserted workpiece (181), is provided. The vacuum type positioning apparatus includes a vacsorb unit (11) and a positioning unit (15). The positioning unit connects with the vacsorb unit. The positioning unit has an attaching wall (1912). The vacsorb unit provides a suction pressure for the positioning unit to attach the inserted workpiece with the attaching wall.

### BACKGROUND OF THE INVENTION

1. Field of the Invention

The present invention relates to vacuum type positioning apparatuses, and particularly to a vacuum type positioning apparatus attaching a workpiece to an insert-molding machine vacuum

2. Description of Related Art

IMD (insert-molding) technology is widely used for manufacturing various kinds of components (e.g., shells) of a portable electronic device (e.g., a mobile phone). For example, an inserted workpiece, i.e., a strengthening member, is typically inserted/attached to an insert-molding machine. The strengthening member is usually used to form/mold a shell therewith and strengthens the whole shell.

The strengthening member is typically attached to an attaching wall of the insert-molding machine via an engagement of at least one positioning hole of the strengthening member into corresponding positioning column disposed on the attaching wall.

However, during molding process, the strengthening member may move away from the attaching wall, or even disengage from the positioning columns, which results in failure of the whole molding process.

Therefore, a heretofore-unaddressed need exists in the art to address the aforementioned deficiencies and inadequacies.

### SUMMARY

In one embodiment of the present invention, a vacuum type positioning apparatus used in insert-molding machine for positioning an inserted workpiece is provided. The vacuum type positioning apparatus includes a vacsorb unit and a positioning unit. The positioning unit connects with the vacsorb unit via at least one pipe. The positioning unit has an attaching wall. The vacsorb unit provides a suction pressure for the positioning unit to attach the inserted workpiece to the attaching wall.

In another embodiment of the present invention, a vacuum type positioning apparatus for positioning a workpiece is provided. The vacuum type positioning apparatus includes a vacsorb unit and a positioning unit. The positioning unit connects with the vacsorb unit via at least one pipe. The positioning unit has an attaching wall. The vacsorb unit creates a pressure difference between the two opposite sides of a workpiece, so as to attach the workpiece to the attaching wall.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present vacuum type positioning apparatus can be better understood with reference to the following drawings. These drawings are not necessarily drawn to scale, the emphasis instead being placed upon clearly illustrating the principles of the present vacuum type positioning apparatus. Moreover, in the drawings like reference numerals designate corresponding parts throughout the several views. Wherever possible, the same reference numbers are used throughout the drawings to refer to the same or like elements of an embodiment.

FIG. 1 is an isometric view of a shell inset-molded by an insert-molding machine incorporating a vacuum type positioning apparatus in accordance with a present embodiment;

FIG. 2 is an exploded, isometric view of positioning unit of the vacuum type positioning apparatus;

FIG. 3 is an assembled view of the positioning unit shown in FIG. 2;

FIG. 4 is a cross-sectional view of the positioning unit shown in FIG. 3, taken along line IV-IV; and

FIG. 5 is a diagram of the vacuum type positioning apparatus in accordance with the present embodiment.

### DETAILED DESCRIPTION OF THE EMBODIMENTS

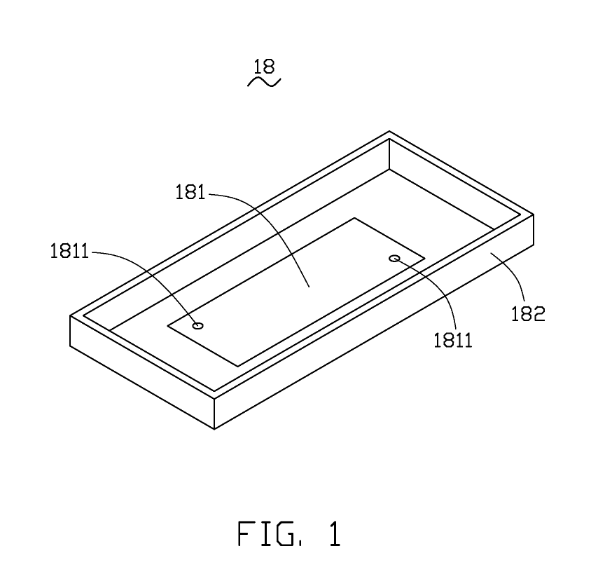

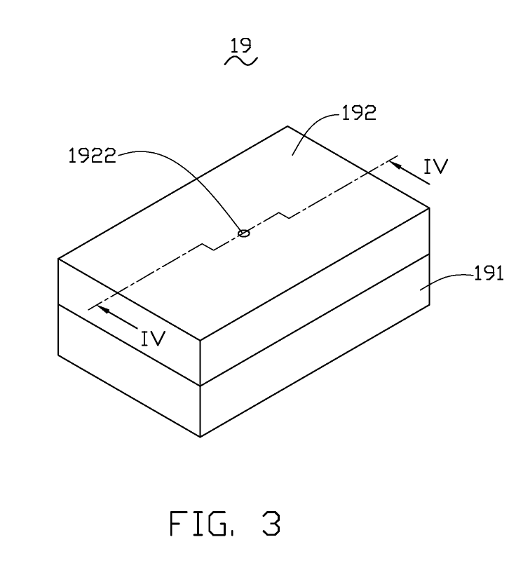

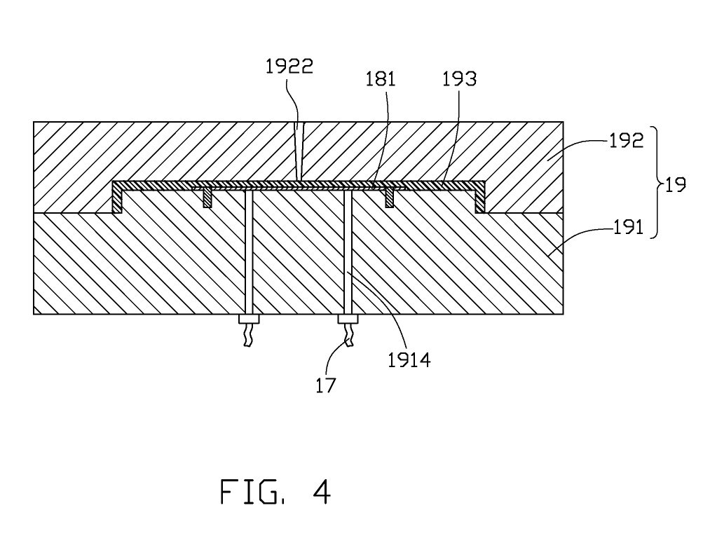

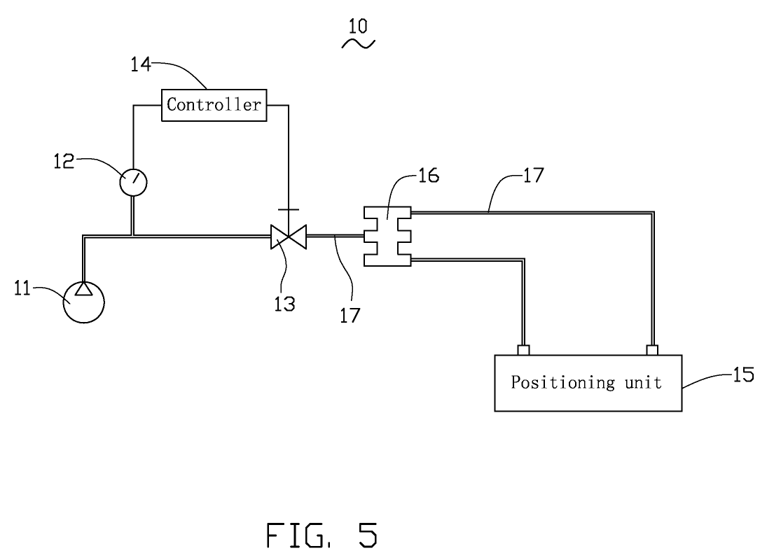

The present vacuum type positioning apparatus is described here in conjunction with the accompanying drawings in FIGS. 1 through 5. The vacuum type positioning apparatus is suitably for insert-molding various kinds of components of a portable electronic device. The portable electronic device can be a mobile phone, a portable digital assistant, or the like. Various kinds of components of a portable electronic device include a shell, a housing, and etc. A shell 18 (shown in FIG. 1) of a mobile phone (not shown) is exemplified as an embodiment to illustrate the principles of the present vacuum type positioning apparatus 10 (shown in FIG. 5).

Referring to FIG. 1 in detail, the shell 18, manufactured by an insert-molding process of an insert-molding machine (not shown), includes an inserted workpiece (i.e., a strengthening member 181) and a molded member 182. The strengthening member 181 is generally a rectangular sheet made of metallic material. The strengthening member 181 is configured (e.g., structured/arranged) to strengthen the molded member 182. As the molded member 182 is integrally formed with the strengthening member 181, strength of the molded member 182 combined with the strengthening member 181 is enhanced. The strengthening member 181 has at least one (e.g., two) positioning hole 1811 defined therethrough. Each positioning hole 1811 facilitates attaching the strengthening member 181 to the insert-molding machine.

The molded member 182, shown in FIG. 1, is a molded shell. The molded member 182 is injection molded with the strengthening member 181, both of which cooperatively form the shell 18. The molded member 182 can be made of plastic material, such as PC (Polycarbonate), ABS (Acrylonitrile Butadiene Styrene), or the like.

Referring further to FIG. 5, the vacuum type positioning apparatus 10 for attaching/positioning the strengthening member 181 with the insert-molding machine, is shown. The vacuum type positioning apparatus 10 includes a vacsorb unit 11, a pressure transducer 12, a control valve 13, a controller 14, a positioning unit 15, a pipe connection 16, and at least one (e.g. two) pipe 17.

The vacsorb unit 11 can be a vacsorb pump, which functions to generate a suction pressure therein. The vacsorb unit 11 can be directly or indirectly coupled/connected to the control valve 13, the pressure transducer 12, the positioning unit 15, and the pipe connection 16 through the pipes 17.

The pressure transducer 12 is used to sense a pressure of the vacsorb unit 11 and transduces (i.e., generates and transmits) a signal corresponding to the pressure to the controller 14. The pressure transducer 12 is electronically coupled/connected to the controller 14. The signal indicates a specific value of the pressure of the vacsorb unit 11 and facilitates the controller 14 controlling an opening/closing of the control valve 13.

The control valve 13 (e.g., a s electromagnetic valve) is disposed between the vacsorb unit 11 and the pipe connection 16 and used to cut or pass the connection between the vacsorb unit 11 and the pipe connection 16.

The controller 14 (e.g., a micro control unit or a programmable logic controller 14) is electronically coupled to the control valve 13 and the pressure transducer 12 for receiving signals from the pressure transducer 12 and control action of the control valve 13. When the insert-molding process starts, the strengthening member 181 needs is required to be attached to the insert-molding machine. As such, the controller 14 controls the control valve 13 to pass the connection of the vacsorb unit 11 and the pipe connection 16. When the value of the suction pressure received by the controller 14 is lower than a provided pressure value, the controller 14 controls the control valve 13 to cut the connection of the vacsorb unit 11 and the pipe connection 16.

The pipe connection 16 corresponds to the two pipes 17 and is advantageously a two-way connection. In other words, the pipe connection 16 connects with the control valve 13 in one way (i.e., with one nodal point) and connects the positioning unit 15 in two ways (i.e., with two nodal points).

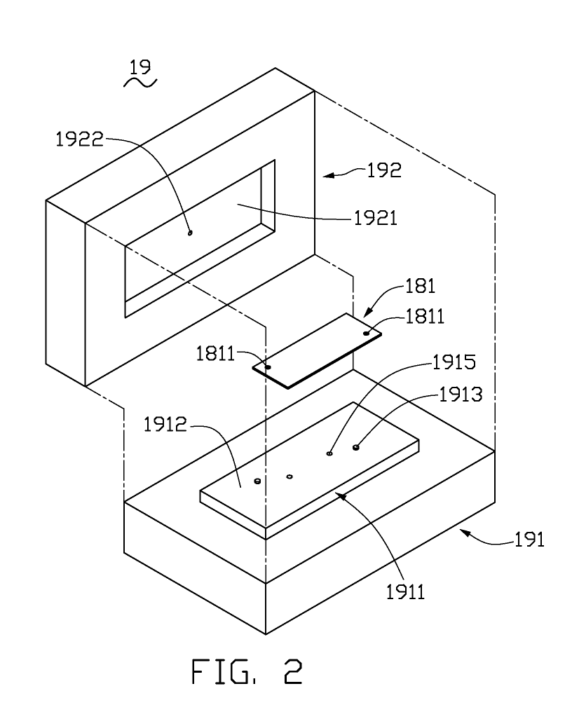

Referring further to FIGS. 2-5, the positioning unit 15 is advantageously a mold 19 incorporated in the insert-molding machine. The positioning unit 15 includes an upper mold 192, a lower mold 191, and a mold core 1911. The mold core 1911 is disposed on the lower mold 191. The mold core 1911 comprises an attaching wall 1912 to which the strengthening member 181 is attached. The attaching wall 1912 has at least one (e.g. two) positioning column 1913 formed thereon and essentially orthogonal thereto. Each positioning column 1913 corresponds to (e.g. aligns with) one respective positioning hole 1811. The lower mold 191 defines at least one through path 1914 through the lower mold 191 and the mold core 1911, and corresponding vacsorb holes 1915 are defined through the attaching wall 1912.

The upper mold 192 defines an upper cavity 1921 therein corresponding to the mold core 1911 of the lower mold 191, i.e., as the upper mold 192 attached/adjoined to the lower mold 191, the upper cavity 1921 and the mold core 1911 cooperatively enclose a molding cavity 193. The molding cavity 193 corresponds to (e.g., be injected to mold the shell 18) the shell 18. The upper mold 192 further defines an injecting path 1922 therethrough, which is used to inject molding materials.

In manufacturing process, the vacsorb unit 11, the control valve 13, the pipe connection 16, and the positioning unit 15 are sequently connected through the pipes 17. Each pipe 17 connects and communicates with one corresponding through path 1914 and one vacsorb hole 1915 of the lower mold 191. The strengthening member 181 is placed and positioned on the attaching wall 1912 of the mold core 1911 via the engagement of the positioning columns 1913 of the mold core 1911 and the positioning holes 1811 thereof. The upper mold 192 is then attached with the lower mold 191 to enclose the strengthening member 181 within the upper cavity 1921 thereof.

After that, the vacsorb unit 11 generates a suction pressure. The suction pressure is sensed by the pressure transducer 12 and transformed into a signal, which is transmitted to the controller 14. The controller 14 controls the control valve 13 to pass the connection between the vacsorb unit 11, the pipe connection 16, and the positioning unit 15. The suction pressure from the vacsorb unit 11 is therefore transmitted to the positioning unit 15 via the pipes 17. The strengthening member 181 is then sorbed and attached to the attaching wall 1912 of the mold core 1911. In this case, the pressure transducer 12 senses the suction pressure and transduces value of the suction pressure to the controller 14. When the value of the suction pressure exceeds the provided pressure value, the controller 14 controls the control valve 13 to cut the connection between the vacsorb unit 11 and the positioning unit 15. As a result of that, the strengthening member 181 is sorbed and firmly/stably attached with the attaching wall 1912.

Then, the molding materials are injected through the injecting path 1922 into the molding cavity 193 of the mold. The molded member 182 is thus molded with the strengthening member 181, whereby the shell 18 is molded.

Main advantages of the present vacuum type positioning apparatus 10 are as followed. The vacuum type positioning apparatus 10 is simple in structure. Due to the suction pressure generated by the vacsorb unit 11, the strengthening member 181 is sorbed and firmly/stably attached to the attaching wall 1912 of the positioning unit 15.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vacuum type positioning apparatus used in insert-molding machine for positioning an inserted workpiece, comprising:
a vacuum unit; and
a positioning unit connected with the vacsorb unit, the positioning unit comprising an attaching wall;
wherein the vacsorb unit provides a suction pressure for the positioning unit to attach the inserted workpiece to the attaching wall.

2. The vacuum type positioning apparatus as claimed in claim 1, wherein the positioning unit further comprises at least one through path and at least one vacsorb hole formed therein, the at least one vacsorb hole being defined through the attaching wall and communicating with the at least one through path, and the vacsorb unit communicating with the at least one through path.

3. The vacuum type positioning apparatus as claimed in claim 2, wherein the vacsorb unit communicates with the at least one through path via at least one corresponding pipe.

4. The vacuum type positioning apparatus as claimed in claim 3, further comprising a pipe connection corresponding to pipes, the pipe connection connecting and communicating the vacsorb unit with the positioning unit.

5. The vacuum type positioning apparatus as claimed in claim 1, further comprising a control valve configured for cutting or passing the connection between the vacsorb unit and the positioning unit.

6. The vacuum type positioning apparatus as claimed in claim 5, further comprising a pressure transducer and a controller, the pressure transducer being configured for sensing and transducing a pressure of the vacsorb unit, the controller being configured for receiving a value of the pressure from the pressure transducer and controlling the control valve.

7. The vacuum type positioning apparatus as claimed in claim 6, wherein the controller compares the value of the pressure with a predetermined pressure value.

8. The vacuum type positioning apparatus as claimed in claim 1, wherein the attaching wall has at least one positioning column formed thereon.

9. The vacuum type positioning apparatus as claimed in claim 1, wherein the positioning unit comprising an upper mold and a lower mold, the lower mold comprising a mold core, the attaching wall being defined with the mold core, the lower mold defining at least one through path and at least one vacsorb hole in the attaching wall thereof, each vacsorb hole being defined through the attaching wall, each vacsorb hole corresponds to each through path, and vacsorb unit connects with each through path.

10. A vacuum type positioning apparatus for positioning a workpiece, comprising:
a vacsorb unit; and
a positioning unit communicating with the vacsorb unit, the positioning unit comprising an attaching wall;
wherein the vacsorb unit enables a pressure difference between two opposite sides of a workpiece when the workpiece is attached to the attaching wall by one of the two opposite sides thereof.

11. The vacuum type positioning apparatus as claimed in claim 10, wherein the positioning unit further comprises at least one through path and at least one vacsorb hole, the at least one vacsorb hole being defined through the attaching wall and communicating with the at least one through path, and vacsorb unit communicating with the at least one through path.

12. The vacuum type positioning apparatus as claimed in claim 11, further comprising a pipe connection connected to a plurality of pipes, the pipe connection being connected between the vacsorb unit and the positioning unit via the pipes.

13. The vacuum type positioning apparatus as claimed in claim 10, further comprising a control valve configured for blocking or releasing the communication between the vacsorb unit and the positioning unit.

14. The vacuum type positioning apparatus as claimed in claim 13, further comprising a pressure transducer and a controller, the pressure transducer being configured for sensing and transducing a pressure of the vacsorb unit, the controller being configured for receiving a value of the pressure from the pressure transducer and controlling the control valve.

15. The vacuum type positioning apparatus as claimed in claim 10, wherein the attaching wall has at least one positioning column formed thereon.

16. The vacuum type positioning apparatus as claimed in claim 10, wherein the positioning unit comprising an upper mold and a lower mold, the lower mold comprising a mold core, the attaching wall being defined with the mold core, the lower mold comprising at least one through path and at least one vacsorb hole, the at least one vacsorb hole being defined through the attaching wall, the at least one vacsorb hole communicating with the at least one through path, the vacsorb unit communicating with the at least one through path.
